(19) United States
(12) Patent Application Publication
(10) Pub. No.: US 2020/0364233 A1
(43) Pub. Date: Nov. 19, 2020

(54) SYSTEMS AND METHODS FOR A CONTEXT SENSITIVE SEARCH ENGINE USING SEARCH CRITERIA AND IMPLICIT USER FEEDBACK

(71) Applicant: WeR.AI, Inc., Rancho Santa Margarita, CA (US)

(72) Inventor: Man Chan, San Jose, CA (US)

(21) Appl. No.: 16/532,404

(22) Filed: Aug. 5, 2019

Related U.S. Application Data
(60) Provisional application No. 62/848,532, filed on May 15, 2019.

(51) Int. Cl. G06F 16/2457; G06F 16/22; G06F 16/93; G06N 20/00

(52) U.S. Cl. CPC G06F 16/24578; G06N 20/00; G06F 16/93; G06F 16/22

(57) ABSTRACT

An example method comprises receiving documents to generate a corpus, generating an index of the documents, searching the corpus using the index and a search criteria to generate search results, ordering the search results, providing the search results to a user device, receiving a selection of one or more documents considered to be relevant, receiving a selection of one or more documents considered to be irrelevant, updating a machine learning model based on the selection of the one or more documents considered to be relevant and the one or more documents considered to be irrelevant, the machine learning model configured to generate a probability of likelihood of relevancy for at least a subset of the documents, re-ordering the search results based on the probability of likelihood of relevancy for each of the at least a subset of the documents, and providing the ordered search results based on the probability.

### CROSS-REFERENCE TO RELATED APPLICATIONS

The present application claims the benefit of U.S. Provisional Patent Application Ser. 62/848,532, filed May 15, 2019 and entitled “Context Sensitive Search Engine by Using Both Implicit and Explicit User Feedback,” which is hereby incorporated by reference herein.

### TECHNICAL FIELD

This disclosure pertains to systems for text search engines that leverage machine learning models and, more specifically, text search engines that leverage explicit (e.g., keywords) and implicit (e.g., identified relevant documents documents) for providing ordered search results.

### BACKGROUND

Searching for information within a set of related documents in an enterprise can be daunting. Documents may be classified differently by different people within and outside of the enterprise. For example, a single business document (e.g., an invoice) may be classified as being from or associated with a shipping department, an accounting department, and/or a customer department. Since there is no standardized methodology for document classification, users must often discover and follow a changing company tradition in order to find desired documents and/or desired information.

To further complicate matters, most documents are mixed and/or stored within any number of databases. As a result, a typical solution to help users to find a document is to use a search engine.

There are generally two major approaches for utilizing a search engine for information retrieval. One approach deals with generic documents and the second approach deals with domain-specific documents. One type of a search engine that deals with generic documents is a keyword search engine (KWSE) such as the Google, Bing, Yahoo, and Elastic search engines. A KWSE will treat each document as a collection of keywords, and a typical KWSE builds an index based on the keywords found in each document. The index may be termed as a “reverse index,” because the searcher often retrieves all documents containing the same keyword or set of keywords. KWSEs will not make any assumption about the domain in a search. For example, a KWSE searching the keyword “apple” will include “apple” as a fruit, “Apple” as a company, and “Apple” as a product in the search results. Essentially, a KWSE is a horizontal search engine (HSE).

A vertical search engine (VSE) is the other type of search engine for searching domain-specific documents. This type of search engine assumes searches are against a specific domain (e.g., finance). For example, a VSE searching for the “apple” should find Apple as a company or as a product due to the limited context. A VSE is typically used in electronic document searches within enterprises.

Both HSEs and VSEs, however, have significant limitations. As mentioned earlier, invoices can have multiple classifications. A VSE will face a similar search challenge like an HSE in that the search engine has to guess or rely on some preference to prioritize the search result.

It will be appreciated that the fewer the keywords in the search, the more documents the search engine will find. While more results suggest that a document might not be missed in the search (which may be a false comfort), a user is then obligated to examine an increasing number of documents. Typically, for an HSE to find a specific document, a user usually must construct a long search query. For example, a user may combine several search keywords with AND, and/or terms to instruct the search engine to make their search more specific and to reduce the number of documents in the search results.

One approach to improve a VSE's capability to deal with domain-specific documents is to build a knowledge graph among domain-specific documents so that the VSE has additional information about the document and context information about the keywords. This requires substantial effort with the help of domain expertise to encode such knowledge (e.g., taxonomy, ontology, and/or the like) into the knowledge graph. This approach, however, is time-consuming and requires domain experts to curate and build a knowledge graph which limits scalability and computational efficiency.

### SUMMARY

An example computing system comprises one or more processors and memory storing instructions that, when executed by the one or more processors, cause the computing system to: receive documents from one or more data sources to generate a corpus, generate an index of the documents based on keywords and phrases contained in each of the documents, receive a search criteria including keywords to search the corpus using the index, search the corpus using the index and the search criteria to generate search results, order the search results, provide the search results to a user device, receive a selection of one or more documents considered to be relevant from the user device, update a machine learning model based on the selection of the one or more documents considered to be relevant, the machine learning model configured to generate a probability of likelihood of relevancy for at least a subset of the documents, re-order the search results based on the probability of likelihood of relevancy for each of the at least a subset of the documents, and provide the ordered search results based on the probability to the user device, the search results including an ordered list of documents.

In some embodiments, the documents may include any computer object with text. The documents may be abstracts and include identifiers of longer documents that the abstracts belong to. The search results may comprise ordering the search results based on TF-IDF. Each document may be encoded as a feature vector.

In some embodiments, the instructions further cause the computing system to receive a selection of one or more documents considered to be irrelevant from the user device. In one example, the machine learning model is further updated based on the selection of the one or more documents considered to be irrelevant

In various embodiments, the machine learning model is a general linear model (GLM) classifier that converts documents into a feature matrix using, at least in part positive features such as labels associated with selected relevant documents and negative features such as labels associated with selected irrelevant documents.

The instructions may further cause the computing system to track each change to the machine learning model and store the information as model information. Further, the instructions may further cause the computing system to provide a list of pre-existing corpuses based on a request from the user device, receive a selection of a pre-existing corpus from the list of pre-existing corpuses, and provide a list of pre-existing machine learning models including model information for at least a subset for the pre-existing machine learning models. Moreover, the instructions may further cause the computing system to receive a request for a particular pre-existing machine learning model from the list of pre-existing corpuses, retrieve the pre-existing corpus, load the particular pre-existing machine learning mode, and provide search results based at least in part on information contained within the model information, the search results being ordered based on the particular pre-existing machine learning model.

An example non-transitory computer readable medium comprising instructions that, when executed, cause one or more processors to perform: receiving documents from one or more data sources to generate a corpus, generating an index of the documents based on keywords and phrases contained in each of the documents, receiving a search criteria including keywords to search the corpus using the index, searching the corpus using the index and the search criteria to generate search results, ordering the search results, providing the search results to a user device, receiving a selection of one or more documents considered to be relevant from the user device, updating a machine learning model based on the selection of the one or more documents considered to be relevant, the machine learning model configured to generate a probability of likelihood of relevancy for at least a subset of the documents, re-ordering the search results based on the probability of likelihood of relevancy for each of the at least a subset of the documents, and providing the ordered search results based on the probability to the user device, the search results including an ordered list of documents.

An example method may comprise receiving documents from one or more data sources to generate a corpus, generating an index of the documents based on keywords and phrases contained in each of the documents, receiving a search criteria including keywords to search the corpus using the index, searching the corpus using the index and the search criteria to generate search results, ordering the search results, providing the search results to a user device, receiving a selection of one or more documents considered to be relevant from the user device, updating a machine learning model based on the selection of the one or more documents considered to be relevant, the machine learning model configured to generate a probability of likelihood of relevancy for at least a subset of the documents, re-ordering the search results based on the probability of likelihood of relevancy for each of the at least a subset of the documents, and providing the ordered search results based on the probability to the user device, the search results including an ordered list of documents.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various FIGS. It is to be expressly understood, however, that the drawings are for purposes of illustration and description only and are not intended as a definition of the limits of the invention.

### BRIEF DESCRIPTION OF THE DRAWINGS

FIG. 1 depicts an example context search engine system (CSE) in an example environment.

FIG. 2 is a depiction of an example CSE system in some embodiments.

FIG. 3 is an example method for searching and providing search results in some embodiments.

FIGS. 4a and 4b include another example of a method for literature review for a clinical evaluation of medical equipment in some embodiments.

FIG. 5 is a method for saving machine learning models in some embodiments.

FIG. 6 is a method for retrieving one or more machine learning models in some embodiments.

FIG. 7 depicts a block diagram of an example digital device according to some embodiments

### DETAILED DESCRIPTION

Some embodiments described herein improve VSE capability by utilizing machine learning and NLP together to overcome limitations associated with using a knowledge graph. For example, a model is updated with user feedback using machine learning.

NLP may encode a document into a feature space. Typically, a parser using NLP may process each word individually, however, there are some domain-specific words that might be domain-specific that the parser may consider to be different words (e.g., “back pain” may be considered as “back” and “pain”). “Back pain” may carry specific meaning. In many NLP applications, separation of these terms may not affect the function of machine learning, however, in some cases it may be critical.

Some embodiments described herein enable specific knowledge to be incorporated into the machine learning process to improve accuracy. By combining both machine learning (ML) modeling and NLP, a VSE may provide improved results but without a requirement for building a knowledge graph. This improves computational efficiency and scalability. For example, considerable time and expense are saved by not requiring a knowledge expert to build the knowledge graph. Further, time is saved, expenses decreased, and performance improved by not requiring the knowledge graph. Moreover, the results may be improved by utilizing reference and/or relevant documents that are selected from search results to generate more focused and improved results over and above that which may have been received through the use of the knowledge graph.

While a knowledge graph is not required, it will be appreciated that a knowledge graph may be utilized in combination with the machine learning modeling and the NLP. For example, the knowledge graph may be utilized for one or more features (e.g., data columns) for machine learning.

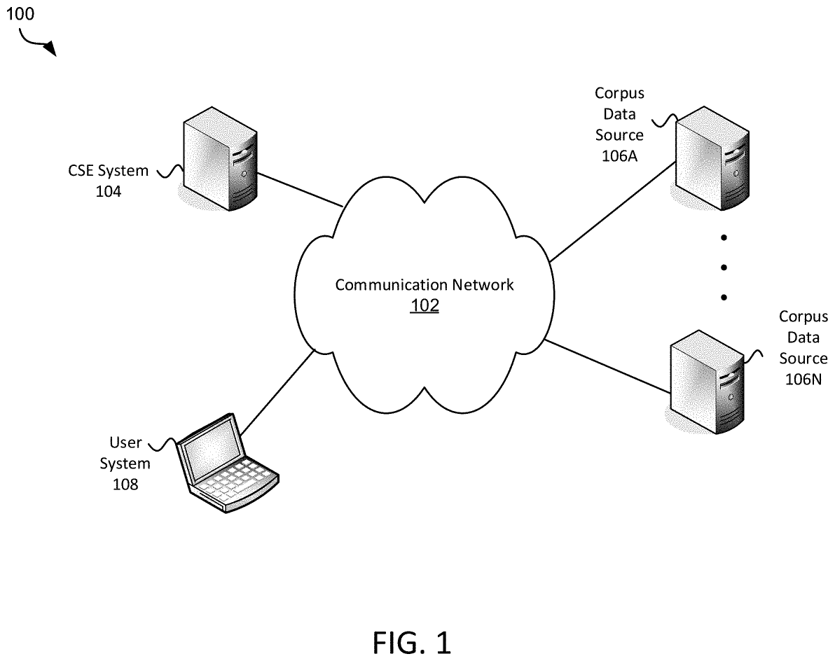

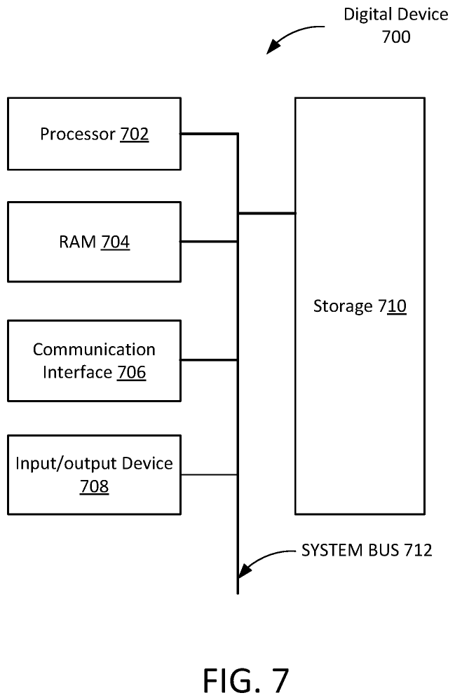

FIG. 1 depicts an example context search engine system (CSE) 104 in an example environment. FIG. 1 includes a communication network 102, CSE system 104, corpus data sources 106A-N, and user system 108. The CSE system 104, the corpus data sources 106A-N, and the user system 108 may each be or include any number of digital devices. A digital device is any device including memory and a processor. An example of a digital device can be found in FIG. 7. It will be appreciated that although FIG. 1 depicts one communication network 102, one CSE system 104, and one user system 108, it will be appreciated that there may be any number of networks, CSE systems, and user systems.

In various embodiments, the CSE system 104 and user system 108 may be part of the same enterprise. An enterprise may include any number of companies, entities, and/or organizations. In some embodiments, none, any, or all of the corpus data sources 106A through N may be a part of the same enterprise as the user system 108. Further, in some embodiments, the CSE system 104 may be part of a third party that provides services to the enterprise of the user system 108.

The communication network 102 may be any network that allows digital devices to communicate. The communication network 102 may be the Internet and/or include LAN and WANs. The communication network 102 may support wireless and/or wired communication. It will be appreciated that any number of communication paths within the communication network 102 may be encrypted and/or otherwise secured.

The CSE system 104 may provide context search services to the user of the user system 108 based on any number of documents from the corpus data sources 106A through N and/or user system 108. Typical keyword search engines have limited help (e.g., Boolean search keywords) for locating documents. The following example embodiment improves the search experience by augmenting the way a user performs a search (utilizing a contextual search engine (CSE)) by combining both explicit and implicit input from the search user. A document may be any file, object, document, image, or the like that contains text or images of text.

In various embodiments, a CSE is a keyword search engine. The CSE system 104 may accept keywords or keywords with Boolean operators (i.e., explicit input). In addition to this, the CSE system 104 may also accept implicit input. Implicit input is information from the user indicating whether one or more of the search results (or portions of the search results) are relevant. Subsequently, the CSE system 104 builds upon a machine learning module using the identified relevant search results (and possibly using search results identified as not being relevant) to improve the machine learning state and improve subsequent search results of the same corpus.

The CSE system 104 may be configured to save and/or load the machine learning model at any state thereby enabling subsequent users to utilize the machine learning model to search that corpus, extend or improve the machine learning model, and/or verify results.

Optionally, the implicit search may include one or more reference documents. A reference document may be a document related to desired CSE search results. The reference documents may provide a machine learning model with context without requiring expert(s) to provide a knowledge map. In various embodiments, the CSE system 104 may receive context from a dictionary of words and phrases that are specific to the field, search area, subject matter, and/or the like.

When the CSE system 104 performs a keyword search, the CSE system 104 may combine both the keyword query to retrieve documents and an initial set of reference document(s) to prioritize search results. In this example, the CSE system 104 may utilize keywords to identify relevant documents from a collection of documents (e.g., a corpus and/or any number of data sources). Reference documents may be utilized to prioritize the search results (e.g., order based on similarity to the reference documents and/or categorize). Prioritization of the search results may be based on similarity of context of the search results to the reference document(s). In some embodiments, reference documents are utilized as selected relevant documents as described herein (e.g., to assist in sorting and/or ranking the results).

After a search of the documents, the CSE system 104 may provide the search results to the user system 108. The user of user system 108 may review the prioritized search results and select one or more relevant documents to feed back into the CSE system 104 for a subsequent search.

For example, selected relevant documents from a previous search may be fed back to the CSE system 104 to build/extend its internal machine learning model. Every update on the reference document(s) and/or relevant documents (e.g., selected documents) may trigger an update of the internal machine learning model. As the machine learning model is updated, more relevant documents may be prioritized for the search user. As follows, as more relevant documents are selected by the user and returned to the CSE system 104, the more accurate the machine learning model. Optionally, more relevant documents may be selected for continued searching to further improve prioritization. By combining explicit keywords, implicit keywords, reference document(s), and relevant document(s), the CSE system 104 may continue to enhance and prioritize the search results for the user.

The corpus data sources 106A through N may include any number of data sources. A data source is any device that may provide and/or store documents and/or other digital content. One or more of the corpus data sources 106A through N may be a part of the same enterprise as the user system 108 or a different enterprise. Corpus data sources 106A through N may include, for example, document management systems, record databases, log databases, invoice systems, accounting systems, marketing systems, medical epic systems, legal systems, chat systems, and/or the like.

The corpus data sources 106A through N may include one or more data sources that are encrypted and/or otherwise secured. In one example, the CSE system 104 may maintain encryption keys, or other authentication to enable access to energy role documents from any number of corpus data sources 106A through N. In another example, a user of the user system 108 may provide encryption keys and/or authorization to provide documents to the CSE system 104 from the one or more data sources.

The user system 108 may be any digital device controlled by a user to provide keywords and reference document identifications to the CSE system 104. The user may optionally provide identification of the corpus to be used and/or the location of the corpus data sources 106A through N. In various embodiments, the CSE system 104 provides search results to the user system 108. The user of the user system 108 may select one or more documents from the search results to provide back to the CSE system 104 as selected relevant documents. Subsequently, the CSE system 104 may utilize the additional selected relevant documents to search the relevant corpus again with the additional information and/or prioritize the search results with the additional information. The system may provide the updated search results back to the user system 108.

As discussed herein, each machine learning model may be per user and/or per specific search task. This model can be saved and reused in the future. For example, a user may use multiple search tasks with different machine learning models with their corresponding reference and relevant document selection(s). This may establish a knowledge base on search tasks. A saved model (e.g., search knowledge) can be shared with other search users to help other search users on their search tasks. In one example, a senior search user could have their search experiences saved to help more junior search users to make their works more effectively.

In some embodiments, the CSE system 104 approach includes a human-in-the-loop in that machine learning is assisted with the help from a human expert to augment and share human intelligent indirectly through machine learning. This may combine the best of both worlds: human intelligent can be captured in the machine, and, at the same time, the machine can learn with human guidance instead of learning from scratch.

In conjunction with the CSE system 104, machine learning models may be saved to establish a natural search context. This context can be used to define different contexts directly and implicitly instead of needing to define extensive search keywords/operators and/or document petitioning in order to create a contextual sensitive search. Different search contexts can be established on the same document set.

Because of the saved machine learning model, the same search tasks may be performed autonomously without search user help. This can help to discover similar or highly relevant documents automatically when such documents are added and available to the search engine.

Because each search task may be independent, the same document may appear in different search tasks. Because of such independence, a search user may tag specific remarks for each document or groups of documents per each search tasks. This will enable the search user to review each search task and/or assist other search users to understand specific search task through this remark communication.

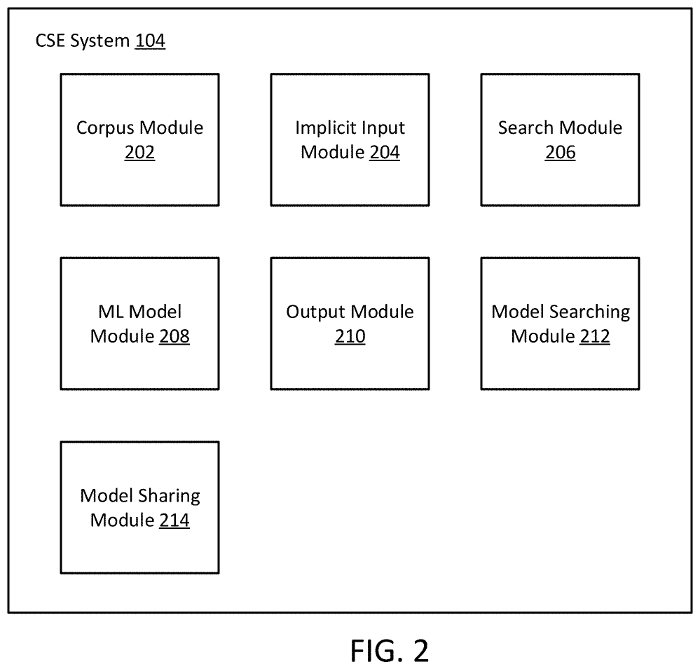

FIG. 2 is a depiction of an example CSE system 104 in some embodiments. The example CSE system 104 includes a corpus module 202, an implicit input module 204, a search module 206, an ML model module 208, an output module 210, a model searching module 212, and a model sharing module 214.

The corpus module 202 is configured to receive one or more sets of documents (i.e., a corpus) from any number of corpus data sources 106A through N. The corpus module 202 may retrieve one or more sets of documents and/or receive one or more sets of documents from any number of data sources. In some embodiments, one or more documents may be or include summaries, abstracts, and/or the like of larger documents. The larger documents may or may not be a part of the corpus that is searched by the CSE system 104. In one example, the CSE system 104 may search abstracts of documents and provide a prioritized listing of results. A user may select one or more of the abstracts and link to or otherwise receive copies of the larger documents at the user system 108.

In various embodiments, user system 108 communicates with the CSE system 104 over the communication network 102. A user at the user system 108 may identify one or more sets of documents to include in the corpus. In some embodiments, the user may identify the location of one or more sets of documents, provide one or more sets of documents, and/or identify locations where one or more sets of documents are stored (e.g., any number of corpus data sources 106A through N).

In various embodiments, the corpus module 202 may receive and store any number of sets of documents from any number of data sources or user systems. The corpus module 202 may, in some embodiments, combine any number of sets of documents from any number of sources to create a single corpus. The corpus module 202 may keep any number of sets of documents separate from any other sets of documents and create a corpus including different sets of documents. The corpus is the set(s) of documents that will be the subject of the search by the CSE system 104. In some embodiments, the corpus may include an unordered, unstructured, and unclassified (e.g., not categorized) collection of electronic documents. The corpus module 202 may, in some embodiments, scan documents, provide optical character recognition functions to identify text and documents, convert documents to one or more formats, and/or the like.

The implicit input module 204 may be optionally configured to receive one or more reference documents identified by the user system 108. A reference document is a document that may characterize the type of information and/or the context of information desired by the user in performing the search. For example, if the user desired documents related to medical research for a particular medical condition, the user may identify one or more particular reference documents that are considered to be well known and seminal in the field to assist in finding similar and/or more current research. The reference documents identified by the user system 108 may be a part of the corpus from the corpus module 202 or may be separate from the corpus.

In some embodiments, the user may provide the reference document(s) to the implicit input module 204 and/or provide the location of the reference document(s) where the reference document(s) may be received.

In some embodiments, the implicit input module 204 and/or the search module 206 may optionally utilize the one or more reference documents to provide context for the search and/or create a machine learning model based on the keywords and reference documents.

The corpus module 202 may include NLP functionality to convert, index, and/or categorize text (e.g., words and phrases) within any number of documents of the corpus. In some embodiments, the search module 206 may parse words or phrases based on domain expertise. In one example, the search module 206 may utilize a domain-specific lookup table/special keyword table which may function similar to a dictionary. The domain-specific lookup table/special keyword table may contain some keywords or phrases considered to be unique for a specific usage. When the corpus module 202 and/or search module 206 identifies keywords, the corpus module 202 and/or search module 206 may convert these keywords as special keywords (e.g., “back pain” becomes “#back_pain”, “code red” becomes “#code_red”). This may enhance the search engine's ability to recognize domain-specific keywords to enhance the accuracy of the machine learning model.

In various embodiments, the corpus module 202 may generate all or part of the domain-specific lookup table/special keyword table based on the reference document(s) provided by the user. In some embodiments, the corpus module 202 parses and indexes words and phrases in the reference documents and builds all or part of the domain-specific lookup table/special keyword table. In one example, the corpus module 202 may identify keyword combinations that are common in the reference documents and then save the combination as phrases in the domain-specific lookup table/special keyword table. The corpus module 202 may also build the domain-specific lookup table/special keyword table based on a dictionary or list of keywords and phrases provide by an expert or other source to provide context for the search.

In some embodiments, the corpus module 202 does not receive any research documents and/or may not build the domain-specific lookup table/special keyword table. Context may be provided by documents from search results identified as being relevant to the searcher's interests.

The corpus module 202 and/or search module 206 may establish a document repository to be the corpus. In some embodiments, the corpus module 202 and/or search module 206 indexes documents using keywords and phrases from each document. This index may be stored inside the corpus. This indexing may be utilized based on the keyword search explicit criteria.

The corpus module 202 and/or search module 206 may encode each document as a feature vector stored inside the search engine to facilitate the machine learning process to train a machine learning model. For new documents introduced to the corpus module 202 and/or search module 206, the corpus module 202 and/or search module 206 may update the keyword index and feature vector for each new document before the search should begin.

The search module 206 may be configured to receive a search criteria from the user system 108 and any number of reference documents to perform a search on the corpus. The search criteria may include, for example, a set of keywords and key phrases, with or without Boolean operators (e.g., using natural language).

The search module 206 may search the index of the corpus based on the explicit search criteria provided by the user (e.g., according to the search criteria entered in a search box). In some embodiments, the search module 206 may have utilized reference document(s) and/or other information to build the domain-specific lookup table/special keyword table. In other embodiments, the search module 206 may not have built the domain-specific lookup table/specific keyword table and/or received reference documents.

In various embodiments, the corpus module 202 may generate the initial corpus and/or retrieve documents from any number of document sources using the search criteria provided by the user. The corpus module 202 may generate the index of the corpus based on the search criteria.

In one example of a document research project, the search module 206 may perform a search of the corpus using the search criteria to generate a set of output results. The search module 206 may rank the retrieved documents (e.g., utilizing term frequency-inverse document frequency or TF-IDF), to make relevant documents to be ranked higher.

The search module 206 may rank the output of the search results in any number of ways. In some embodiments, the search module 206 may determine a similarity of each document in the search results to one or more reference documents. Similarity may be determined in any number of ways including determining distances between documents based on commonality of keywords and phrases, context, and/or the like.

The search module 206 may utilize the search criteria and the optional reference documents to build a machine learning model that may be stored and used by any number of subsequent users. After the search module 206 provides the search results (e.g., via the output module 210), the implicit input module 204 may receive feedback from the user. The feedback may include different criteria, selection of relevant documents from the search results, rejection of one or more documents of the search results, requests for different methodology for model creation, and/or the like. As a result, the search module 206 and/or the implicit input module 204 may modify or change the machine learning model based on the information from the user after search results are provided.

Once the search results are provided to the user, the user may select any number of documents as being relevant and/or optionally not relevant to the user's needs. Selected relevant documents are termed herein as “relevant documents.” It will be appreciated that the user may also provide a justification or notes associated with one or more selected relevant documents and/or selected irrelevant documents. As a result, a search session may be documented and reasons for inclusion or exclusion of documents (e.g., reasons for documents noted as being relevant or not relevant) may be saved for subsequent review (e.g., by the searcher, supervisor, or a different searcher that may be looking for the same or similar information).

Documents identified as not being relevant may be omitted from the search results and subsequent search results. In other embodiments, documents identified as not being relevant may be re-ranked towards the bottom of the search results.

The search module 206 may receive the selected relevant documents and search the corpus again using the keywords or simply re-order the existing search results. The new search results may then be ranked based on similarity to the selected relevant documents. As a result, the search results may be improved and curated by the user. The process may continue with the searcher selecting one or more additional relevant documents (or selecting irrelevant documents) and again, running the search. In various embodiments, each search may utilize an increasing set of selected relevant documents which may or may not include the reference documents.

As discussed herein, one search session may be started with receiving a set of reference documents and searches with different keywords. Because the search results may depend on the previous user action (e.g., accepting and/or rejecting documents in the search result), subsequent searches within a research session may be considered a unit of work. Searches with the same reference documents and keywords may be considered different research as the machine learning model built for each research can be different.

After the search, the search module 206 may produce a list of document titles, and/or other document information as well as optional links to documents fulfilling the search criteria. The list may also be ordered according to the relevancy of the documents. More relevant documents may be shown first. Since this list may be long, these documents may be arranged in pages. After a researcher finishes scanning the first page, the researcher may select the second or next pages which contain the rest of the documents.

A researcher (user) may draw a conclusion based on the search results, selected relevant documents, selected irrelevant documents as well as a set of search criteria so that other researchers (maybe more senior with authority) can validate the research conclusion with the corresponding included and excluded documents, and search criteria.

The machine learning (ML) model module 208 may build and/or store the ML (machine learning) model. In various embodiments, the ML model module 208 may provide metadata or other descriptive information associated with each model. For example, the ML model module 208 may identify and save model information associated with one or more machine learning models. For example, model information may include a corpus identifier (e.g., identifying the corpus and/or location of the corpus associated with the machine learning module), keywords, reference document identifier(s) (e.g., an identifier provided by the user that identifies a reference document), relevant document identifier(s) (e.g., an identifier provided by the user that identifies a relevant document), irrelevant document identifier(s) (e.g., an identifier provided by the user that identifies an irrelevant document), and that like that contributed to creation of the machine learning model. In some embodiments, the user, supervisor, or the like may provide categories, tags, or descriptive information in order to categorize and provide additional information for one or more models.

The machine learning models and/or model information may be stored in any data structure (e.g., table or database). The machine learning models and/or model information may be stored along with the relevant corpus in a database at the CSE system 104 or any other location (e.g., corpus data source or user system 108).

The model searching module 212 may be configured to identify and/or provide one or more machine learning models for any number of users. In one example, a user of the user system 108 may utilize a GUI to select a previously searched corpus. The model searching module 214, using model information, may provide a list of models associated with the selected corpus. The GUI may provide that list to the user. The list of models may include any amount of model information including, but not limited to, dates of creation, time of creation, keywords, reference document identifiers, irrelevant document identifiers, and/or relevant document identifiers that were used in the creation of that particular model.

In some embodiments, the model searching module 212 may further provide filtering functions that enable the user to filter the list of models to include only specifically desired models. For example, the user may wish to view only models that are created at a specific time or date. In another example, the user may wish to view only models created with specific relevant documents and/or keywords. It will be appreciated that there may be many ways to filter the list of models based on the model information.

Using the stored models, it will be appreciated that supervisors will be able to re-create, verify, justify, and/or extend previous searches. As a result, it is more efficient and technically faster to build upon the results of previous work thereby increasing scalability.

The model sharing module 214 may be configured to create and/or control permissions of different models. In one example, a user may control permissions such that only specific other users or authorized individuals may view and/or utilize their machine learning models. It will be appreciated that some machine learning models may be saved with “read-only” permissions which enable others to create copies of machine learning models without overwriting those models. Because a model may change with the addition of new selected relevant documents and/or keywords, a user may wish to preserve and document a list of models as well as an indication of how the models were built and how they were changed over time.

A module may be hardware (e.g., an integrated chip, ASIC, or the like), software, or a combination of both.

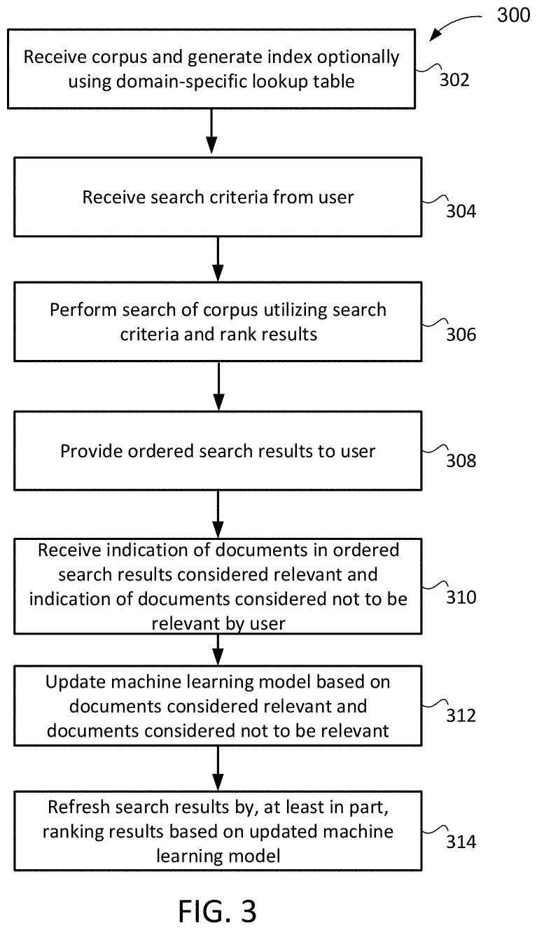

FIG. 3 is an example method for searching and providing search results in some embodiments. In step 302, the corpus module 202 receives a corpus. As discussed herein, the corpus may include any number of sets of documents received from any number of data sources. The corpus module 202 may receive any number of sets of documents and/or retrieve any number of sets of documents from any number of sources as well as user systems. It will be appreciated that the documents may include a variety of different types of files including, for example, webpages, images, PDFs, and/or the like.

The corpus module 202 may identify keywords and phrases within all or some of the corpus (e.g., using NLP techniques). In one example the corpus module 202 may parse keywords and phrases from any number of the documents of the corpus. The corpus module 202 may utilize the domain-specific lookup table/special keyword table to identify phrases and/or convert keywords. A corpus module 202 may create an index of documents in the corpus. The corpus module 202 may encode each document as a feature vector stored inside the corpus to facilitate the machine learning process to train a machine learning model (e.g., rank model).

In step 304, the search module 206 may receive search criteria. For example, a researcher may enter a search criteria related to research (e.g., pacemaker safety) to a search box of the CSE system 104 (e.g., via a webpage on a browser or GUI of an application displayed on the user system 108). In case there are special keywords through table lookup, all or part of the criteria may be translated into a special format. In some embodiments, the search module 206 may also receive research document identifiers from a user of user system 108.

In step 306, the search module 206 may perform a search of the corpus utilizing the search criteria identified by the user. The search module 206 may retrieve documents from the corpus fulfilling the search criteria. In one example, the search module 206 can do this by retrieving documents and checking whether a document fit with the search criteria.

Depending on the specificity of the search criteria, there may be hundreds or thousands of documents fitting the criteria. For example, the keyword “heart” may match numerous documents that contain this word. In some embodiments, if no reference documents were provided, order of the search module 206 search results may be based on a default ranking algorithm (e.g., TF-IDF to prioritize the documents containing the keywords with higher TF-IDF score).

In step 308, the output module 210 may provide the ordered search results to the researcher (e.g., user). When the result page is displayed to the researcher, the researcher may scan a list of documents (e.g., using an abstract of each document) to determine whether the document is relevant or irrelevant to the research. In the result page, a graphical user interface (GUI) may provide a field for the researcher to specify whether the document should be included or excluded as well as remarks regarding the selections. The search engine may keep all remarks from the researcher for a particular search session.

In step 310, the search module 206 may receive an indication (e.g., identifiers) of documents that the researcher considers to be relevant. In some embodiments, the search module 206 may receive an indication of documents (e.g., identifiers) that the researcher considers to be irrelevant. The search module 206 and/or ML model module 208 may train a machine learning model based on the inclusion and/or exclusion of documents identified by the researcher. In some embodiments, the search module 206 and/or ML model module 208 trains the machine learning model such that those documents that are selected by the researcher as relevant are likely to be prioritized to the top of the list of search results. This machine learning model may be used to replace the default ranking algorithm to rank the future results.

In step 312, the output module 210 may refresh search results based on the researcher's feedback.

Due the machine learning model, the new document order may be, in some embodiments, more or less ranked according to the inclusion and/or exclusion of documents (e.g., those documents identified as being relevant and/or irrelevant). In various embodiments, other similar documents to the inclusion may be more likely to be prioritized higher. Exclusion documents will be more likely to be deprioritized.

With the help of the ML model module 208, more training examples may be collected and the accuracy of the machine learning model may be improved so that the researcher will more likely to find the relevant documents. Due to this positive enhancement, the speed of finding relevant documents may be higher.

As discussed herein, a researcher may enter a number of reference documents prior to initiation of the search session. This can be done, for example, by identifying documents using well defined location (e.g., url), or copy-and-paste document content to the search session. Because of these reference documents, the search engine may train a machine learning ranking model before the search using search criteria.

The search module 206 and/or ML model module 208 may re-train a machine learning model based on the selected relevant and selected irrelevant documents and/or remarks provided by the user and reference documents in such a way that the inclusions (e.g., selected relevant documents) and reference documents will be more likely to be prioritized higher and exclusion documents will more likely to be deprioritized (or eliminated from the search results).

Due the machine learning model, the new document order may be ranked according to the inclusion and exclusion indications. Therefore, other similar documents to the inclusion may more likely to be prioritized higher. With the help of the ML model module 208, more training examples may be collected therefore the accuracy of the machine learning model may be improved so that researcher will more likely to find the relevant documents. Due to this positive enhancement, the speed of to find relevant documents may be higher.

During a search session, the search result may be determined by the search criteria, reference documents, and the search remarks. If the ML model module 208 saves information per each research, the result page may be the same. Due the stochastic nature of some machine learning model, the ML model module 208 may save the model parameters so that the same search results can be regenerated.

This ML model module 208 may provide a facility to save the search offline so that the same research can be conducted later on in time, or pass it to other researchers for further research, verify, and/or justify the approach and results.

Since each search session can be saved, the search module 206 may perform new search on behalf of the researcher in case new documents are added to the repository.

A threshold on the rank may be set where the new documents from an automated search. For example, the search module 206 may add new documents to the corpus, perform a search based on the saved parameters (e.g., search criteria and relevant documents) and can check whether there is a new document appear from the top 100 in comparison to a previous search. Since the search is already specified by both the reference document(s), the selected document(s), and the keywords, if there is are relevant documents to this research, the document may appear at the beginning of the search results.

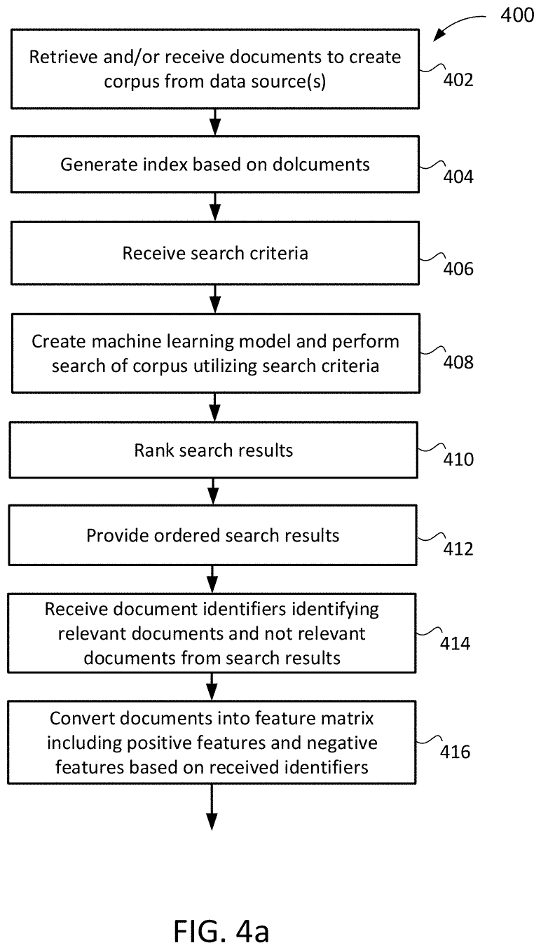

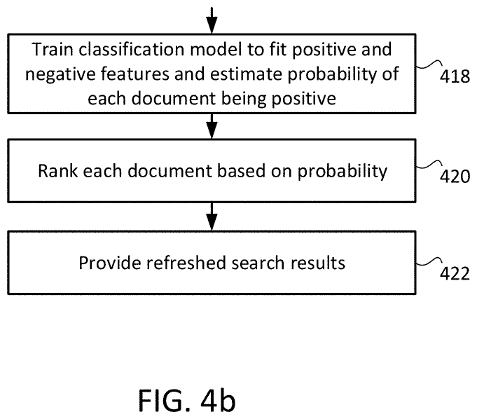

FIGS. 4a and 4b include another example of a method for literature review for a clinical evaluation of medical equipment in some embodiments. A clinical evaluation often details and documents an evaluation to identify, assess, and analyze relevant data pertaining to safety and performance. In providing a clinical evaluation of medical equipment, such as a rotational catheter in this example, a literature search is performed to collect relevant information about clinical background, current knowledge, and state of the art of the device under evaluation.

In step 402, the corpus module 202 may retrieve documents from one or more sources to generate a corpus. In one example for determining such relevant information regarding the rotational catheter, such sources may include the Diagnostic and Interventional Cardiology, Embase, Endovascular Today, The American Heart Association, and the European Society of Cardiology. The documents from the sources that make up the corpus may be summaries or abstracts of larger documents maintained at the different sources. In other embodiments, the documents from the sources may be full documents, part of documents, or the like.

In creating the corpus, the corpus module 202 may search any number of search engines (e.g., a “metasearch”) to collect documents. The corpus module 202 may utilize a search criteria (e.g., that is different, similar, or the same search criteria in step 406) to retrieve the documents from any number of the different search engines. In some embodiments, the corpus module 202 may generate a corpus based on the search results (e.g., including all documents received or a subset of documents such as the first few hundred or thousands of search results from each search engine).

In step 404, the corpus module 202 may generate an index based on the documents. The corpus module 202 may parse words and phrases from the documents for building the index. Features may include keyword frequency and documents may be ranked. In one example, the keyword frequency similarity may be compared to one or more reference documents for ranking and/or creation of a lookup table to identify context and phrases.

In step 406, the search module 206 may receive a search criteria. In one example, search criteria may include search terms, questions, and selection criteria from a searcher (e.g., a user). Examples of search terms may include “Current AND Coronary AND intravascular ultrasound,” “Advantage AND intravascular ultrasound,” and “Disadvantage AND intravascular ultrasound.” Examples of Search questions may include “Does the use of IVUS during the percutaneous coronary intervention improve patient outcomes?” and “What are the advantages of using IVUS?” Selection Criteria may include literature published in the last three years, literature answers one or more search questions, and literature contains information regarding the latest IVUS technology.

In step 408, the search module 206 may create a machine learning model such as a classification model and performs an initial search of the corpus based on the search criteria to generate search results.

In step 410, the search module 206 may rank the search results based on any methodology (e.g., TF-IDF).

In step 412, the output module 210 may provide the ranked results to the researcher. In one example, the ranked results are provided in a GUI provided by a user system 108. The GUI of the user system 108 may provide an option to identify any number of documents as relevant. The GUI may additionally provide an option to identify any number of documents as not relevant. Further, the GUI of the user system 108 may provide a field or other structure to identify reasons (e.g., text, radio buttons, or the like) for the document to be relevant or irrelevant.

In step 414, the search module 206 may receive the list of document identifiers that identify documents that are considered by the user to be relevant and/or not relevant to the desired query and/or search results.

The search module 206 may refresh the ordered list of documents based on the likelihood of being positively selected documents. For example, the search module 206 may utilize or modify the classification model based on selected relevant documents (e.g., positive examples). In some embodiments, the search module 206 may also utilize or modify the classification model based on selected irrelevant documents (e.g., negative examples). It will be appreciated that the search module 206 may utilize selected relevant documents and no selected irrelevant documents or both selected relevant documents and selected irrelevant documents. The corpus may be scored with the model to produce the likelihood per each document in the corpus. The higher the likelihood, the higher they may be on the ordered list of documents.

The ML model module 208 may update the machine learning model based on the selected relevant documents and the selected irrelevant documents. In one example, the ML model module 208 may utilize a general linear model (GLM) classifier. Documents selected as being relevant may be labeled as positive for machine learning. All other documents or those marked as being irrelevant may be labeled as negative for machine learning.

In step 416, the ML model module 208 may convert documents into a feature matrix using a dictionary including positive features (e.g., labels) and negative features in the feature matrix.

In step 418, the ML model module 208 may train the GLM classification model to fit the positive and negative features, and then estimate the probability of each document being positive (e.g., utilizing general linear model (GLM) classifier as discussed herein).

In step 420, the search module 206 ranks each document or a subset of documents based on the probability of each document being positive and/orders the documents based on rank.

In step 422, the output module 210 provides the refreshed search results in the updated order to the researcher.

It will be appreciated that the process may continue where the researcher may continue to select documents as relevant and/or not relevant and then request that the machine learning model be updated and the documents scored for probability of being positive in view of the additional selected relevant documents and/or selected irrelevant documents.

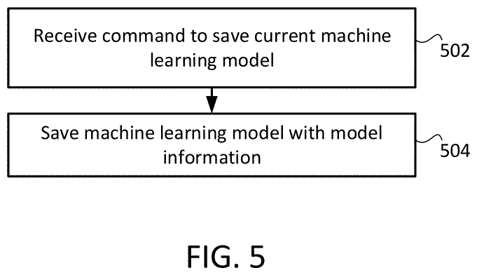

FIG. 5 is a method for saving machine learning models in some embodiments. In this example, method steps 502-504 make take place before or after the machine learning model is updated in FIG. 4.

In step 502, the researcher may provide a command to save the current machine learning module. In some embodiments, the researcher may provide comments or information to add to the machine learning model to be saved.

In step 504, in response to the command, the ML model module 208 saves the machine learning model with model information. The model information may include keywords, a list of reference documents (if any), a list of selected relevant documents, and a list of selected irrelevant documents. Included in the model information may be comments as to why all or some of the relevant documents were selected by the user (e.g., as inputted by the user) and/or comments as to why all or some of the irrelevant documents were selected by the user. The model information may also identify the date/time that the machine learning model was created, the date/time that the machine learning model was saved, the corpus associated with the machine learning model, a log of past changes to the machine learning model, the name of the user that made changes to the machine learning model, and/or the like (e.g., information as to past changes of the machine learning model and the name of the user that made changes may be received from the user system 108 and stored by the CSE system 104).

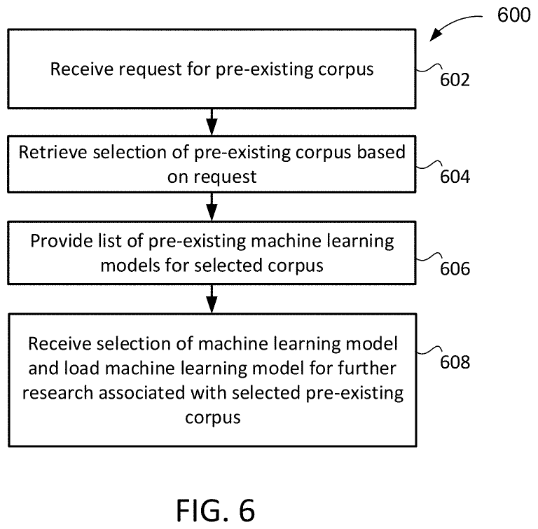

FIG. 6 is a method for retrieving one or more machine learning models in some embodiments. In step 602, a researcher may request a pre-existing corpus. In one example, a corpus may already be created based on documents from any number of data sources. In some embodiments, the researcher utilizes a GUI on the user system 108 to request a list of preexisting corpuses. The corpus module 202 may provide the list of preexisting corpuses that were created for previous researchers.

In some embodiments, the GUI on the user system 108 may list the different corpuses for different sets of documents based on date, subject matter, or the like. In some embodiments, the researcher may identify or provide a category of desired corpuses (e.g., based on subject matter). The corpus module 202 may receive the request and provide a subset of preexisting corpuses in response to the request.

In step 604, the researcher may select a pre-existing corpus from the list of pre-existing corpuses. The corpus module 202 may load the selected corpus and identify any number of machine learning models associated with the selected corpus. In one example, there may be several machine learning models associated with the selected corpus. Each of the several machine learning models may be, for example, an updated version of the machine learning model from a single previous research session.

In step 606, the researcher may be provided, via the GUI, a list of pre-existing machine learning models for the selected corpus. The list may be organized by date or time of creation or any other information. The GUI may provide any or all model information associated with each of the available machine learning models (e.g., keywords, a list of reference documents (if any), a list of selected relevant documents, a list of selected irrelevant documents, keywords, previous researcher that created the machine learning model, results from the previous research, and/or the like).

In step 608, the researcher may select a machine learning model from the list. The ML model module 208 may retrieve or load the previous machine learning model and/or provide any other model information to the researcher. The researcher may then retrieve results from the search (e.g., ranked based on classifications as discussed herein), review selected relevant documents as well as justification as to why the documents were considered relevant, review selected irrelevant documents as well as justification as to why the documents were not considered relevant, and/or the like.

In various embodiments, it will be appreciated that by storing the machine learning models. The CSE system 104 may automate a search of a corpus and provide or store search results. For example, a corpus may receive new documents periodically. These new documents may include new logs, new accounting documents, new legal e-discovery documents, new medical research documents, new financial documents, and/or the like. These new documents may be added to a preexisting corpus. The CSE system 104 may periodically index the new documents to combine with a previously created index, re-execute a search of the updated corpus based on stored keywords using a previously created machine learning model (e.g., using previously classifications) and generating ranked search results which may be stored and/or provided to a user.

FIG. 7 depicts a block diagram of an example digital device 700 according to some embodiments. Digital device 700 is shown in the form of a general-purpose computing device. Digital device 700 includes processor 702, RAM 704, communication interface 706, input/output device 708, storage 710, and a system bus 712 that couples various system components including storage 710 to processor 702.

System bus 712 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Digital device 700 typically includes a variety of computer system readable media. Such media may be any available media that is accessible by the digital device 700 and it includes both volatile and nonvolatile media, removable and non-removable media.

In some embodiments, processor 702 is configured to execute executable instructions (e.g., programs). In some embodiments, the processor 1004 comprises circuitry or any processor capable of processing the executable instructions.

In some embodiments, RAM 704 stores data. In various embodiments, working data is stored within RAM 704. The data within RAM 704 may be cleared or ultimately transferred to storage 710.

In some embodiments, communication interface 706 is coupled to a network via communication interface 706. Such communication can occur via Input/Output (I/O) device 708. Still yet, the digital device 700 may communicate with one or more networks such as a local area network (LAN), a general wide area network (WAN), and/or a public network (e.g., the Internet).

In some embodiments, input/output device 708 is any device that inputs data (e.g., mouse, keyboard, stylus) or outputs data (e.g., speaker, display, virtual reality headset).

In some embodiments, storage 710 can include computer system readable media in the form of volatile memory, such as read-only memory (ROM) and/or cache memory. Storage 710 may further include other removable/non-removable, volatile/non-volatile computer system storage media. By way of example only, storage 710 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CDROM, DVD-ROM or other optical media can be provided. In such instances, each can be connected to system bus 712 by one or more data media interfaces. As will be further depicted and described below, storage 710 may include at least one program product having a set (e.g., at least one) of program modules that are configured to carry out the functions of embodiments of the invention. In some embodiments, RAM 704 is found within storage 710.

Program/utility, having a set (at least one) of program modules may be stored in storage 710 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein. A module may be hardware (e.g., ASIC, circuitry, and/or the like), software, or a combination of both.

It should be understood that although not shown, other hardware and/or software components could be used in conjunction with the digital device 700. Examples include, but are not limited to: microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of one or more embodiments may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband/or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a nontransitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A computing system comprising:
one or more processors; and
memory storing instructions that, when executed by the one or more processors, cause the computing system to:
receive documents from one or more data sources to generate a corpus;
generate an index of the documents based on keywords and phrases contained in each of the documents;
receive a search criteria including keywords to search the corpus using the index;
search the corpus using the index and the search criteria to generate search results;
order the search results;
provide the search results to a user device;
receive a selection of one or more documents considered to be relevant from the user device;
update a machine learning model based on the selection of the one or more documents considered to be relevant, the machine learning model configured to generate a probability of likelihood of relevancy for at least a subset of the documents;
re-order the search results based on the probability of likelihood of relevancy for each of the at least a subset of the documents; and
provide the ordered search results based on the probability to the user device, the search results including an ordered list of documents.

2. The system of claim 1, wherein the documents may include any computer object with text.

3. The system of claim 1, wherein the documents are abstracts and include identifiers of longer documents that the abstracts belong to.

4. The system of claim 1, wherein order the search results comprises ordering the search results based on TF-IDF.

5. The system of claim 1, wherein each document is encoded as a feature vector.

6. The system of claim 1, wherein the machine learning model is a general linear model (GLM) classifier that converts documents into a feature matrix using, at least in part positive features such as labels associated with selected relevant documents and negative features such as labels associated with selected irrelevant documents.

7. The system of claim 1, wherein the instructions further cause the computing system to track each change to the machine learning model and store the information as model information.

8. The system of claim 7, wherein the instructions further cause the computing system to provide a list of pre-existing corpuses based on a request from the user device, receive a selection of a pre-existing corpus from the list of pre-existing corpuses, and provide a list of pre-existing machine learning models including model information for at least a subset for the pre-existing machine learning models.

9. The system of claim 8, wherein the instructions further cause the computing system to receive a request for a particular pre-existing machine learning model from the list of pre-existing corpuses, retrieve the pre-existing corpus, load the particular pre-existing machine learning mode, and provide search results based at least in part on information contained within the model information, the search results being ordered based on the particular pre-existing machine learning model.

10. The system of claim 1, wherein the instructions further cause the computing system to receive a selection of one or more documents considered to be irrelevant from the user device and the machine learning model is updated based on the selection of the one or more documents considered to be relevant.

11. A non-transitory computer readable medium comprising instructions that, when executed, cause one or more processors to perform:
receiving documents from one or more data sources to generate a corpus;
generating an index of the documents based on keywords and phrases contained in each of the documents;
receiving a search criteria including keywords to search the corpus using the index;
searching the corpus using the index and the search criteria to generate search results;
ordering the search results;
providing the search results to a user device;
receiving a selection of one or more documents considered to be relevant from the user device;
updating a machine learning model based on the selection of the one or more documents considered to be relevant, the machine learning model configured to generate a probability of likelihood of relevancy for at least a subset of the documents;
re-ordering the search results based on the probability of likelihood of relevancy for each of the at least a subset of the documents; and
providing the ordered search results based on the probability to the user device, the search results including an ordered list of documents.

12. The non-transitory computer readable medium of claim 11, wherein the documents may include any computer object with text.

13. The non-transitory computer readable medium of claim 11, wherein the documents are abstracts and include identifiers of longer documents that the abstracts belong to.

14. The non-transitory computer readable medium of claim 11, wherein order the search results comprises ordering the search results based on TF-IDF.

15. The non-transitory computer readable medium of claim 11, wherein each document is encoded as a feature vector.

16. The non-transitory computer readable medium of claim 11, wherein the machine learning model is a general linear model (GLM) classifier that converts documents into a feature matrix using, at least in part positive features such as labels associated with selected relevant documents and negative features such as labels associated with selected irrelevant documents.

17. The non-transitory computer readable medium of claim 11, wherein the instructions further cause the one or more processors to to track each change to the machine learning model and store the information as model information.

18. The non-transitory computer readable medium of claim 17, wherein the instructions further cause the one or more processors to provide a list of pre-existing corpuses based on a request from the user device, receive a selection of a pre-existing corpus from the list of pre-existing corpuses, and provide a list of pre-existing machine learning models including model information for at least a subset for the pre-existing machine learning models.

19. The non-transitory computer readable medium of claim 18, wherein the instructions further cause the one or more processors to receive a request for a particular pre-existing machine learning model from the list of pre-existing corpuses, retrieve the pre-existing corpus, load the particular pre-existing machine learning mode, and provide search results based at least in part on information contained within the model information, the search results being ordered based on the particular pre-existing machine learning model.

20. The non-transitory computer readable medium of claim 11, wherein the instructions further cause the one or more processors to perform receiving a selection of one or more documents considered to be irrelevant from the user device and wherein updating the machine learning model is based on the selection of the one or more documents considered to be relevant and the one or more documents considered to be irrelevant.

21. A method being implemented by a computing system including one or more physical processors and storage media storing machine-readable instructions, the method comprising:
receiving documents from one or more data sources to generate a corpus;
generating an index of the documents based on keywords and phrases contained in each of the documents;
receiving a search criteria including keywords to search the corpus using the index;
searching the corpus using the index and the search criteria to generate search results;
ordering the search results;
providing the search results to a user device;
receiving a selection of one or more documents considered to be relevant from the user device;
updating a machine learning model based on the selection of the one or more documents considered to be relevant, the machine learning model configured to generate a probability of likelihood of relevancy for at least a subset of the documents;
re-ordering the search results based on the probability of likelihood of relevancy for each of the at least a subset of the documents; and
providing the ordered search results based on the probability to the user device, the search results including an ordered list of documents.
